(19) United States
(12) Patent Application Publication
(10) Pub. No.: US 2013/0170799 A1
(43) Pub. Date: Jul. 4, 2013

(54) OPTICAL FIBER CONNECTOR

(71) Applicant: YI-ZHONG SHEU, Tu-Cheng (TW)

(72) Inventor: YI-ZHONG SHEU, Tu-Cheng (TW)

(73) Assignee: HON HAI PRECISION INDUSTRY CO., LTD., Tu-Cheng (TW)

(21) Appl. No.: 13/437,018

(22) Filed: Apr. 2, 2012

(30) Foreign Application Priority Data
Dec. 28, 2011 (TW) 100149251

(51) Int. Cl. G02B 6/36

(52) U.S. Cl. 385/89

(57) ABSTRACT

An optical fiber connector includes a shell, a printed circuit board (PCB), and an optical-electrical convertor received in the shell. The PCB includes a loading surface. The optical-electrical convertor includes a substrate, a light emitting module, a light receiving module, a connecting block, a first converging lens, a second converging lens, a first fiber group, and a second fiber group. The substrate is positioned on the loading surface. The connecting block is fixed on the substrate, and defines a first channel and a second channel parallel to the loading surface. The light emitting module and the light receiving module are fixed on the substrate and electrically connected to the PCB. The first fiber group and the second fiber group are received in the first channel and the second channel respectively.

### BACKGROUND

1. Technical Field

The present disclosure relates to optical fiber connectors, and particularly, to an optical fiber connector which can be used as an optical receiving terminal or an optical emitting terminal.

2. Description of Related Art

The light signals through optical fiber connectors need to be reflected by reflectors during optical signal transmission, and thus optical signal loss is increased. Therefore, the transmitting efficiency of the optical signals is reduced.

Therefore, it is desirable to provide an optical fiber connector that can overcome the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, exploded view of an optical fiber connector, according to an exemplary embodiment.

FIG. 2 is a schematic, assembled view of the optical fiber connector of FIG. 1.

### DETAILED DESCRIPTION

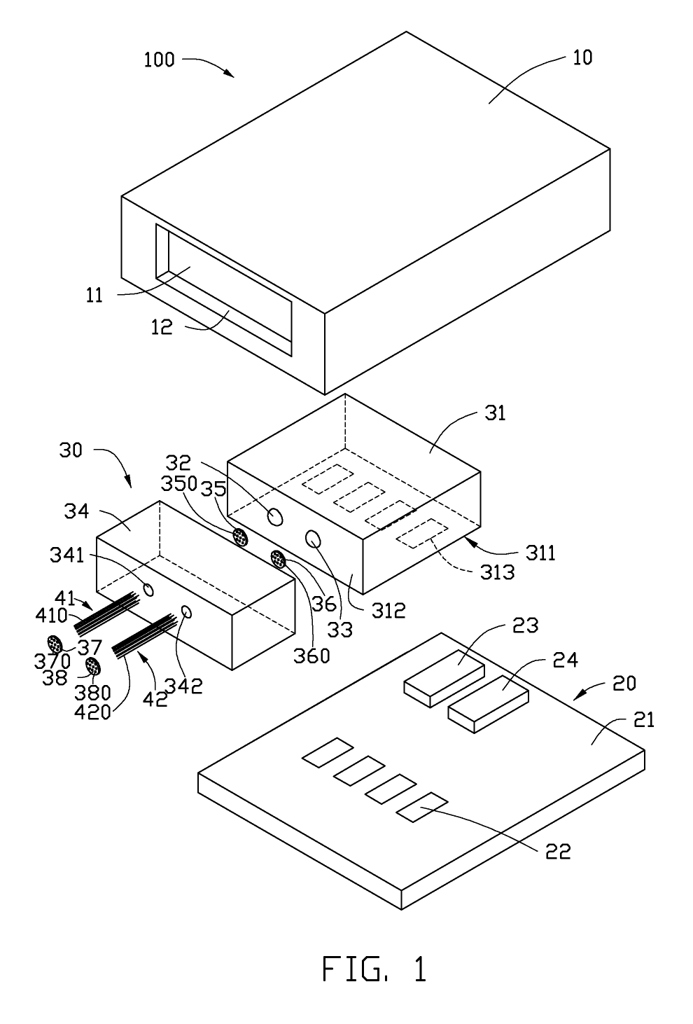

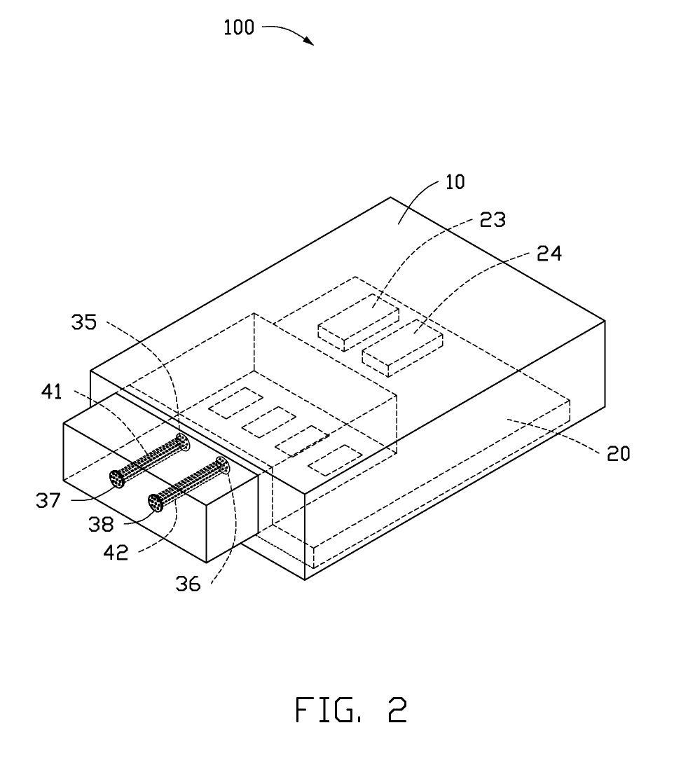

Referring to FIG. 1 and FIG. 2, an optical fiber connector 100, according to an embodiment, includes a cuboid shell 10, a printed circuit board (PCB) 20, and an optical-electrical converter 30.

The shell 10 defines a receiving groove 11. The receiving groove 11 has an opening 12.

The PCB 20 is received in the receiving groove 11, and includes a loading surface 21. A number of first pads 22, a first chip 23, and a second chip 24 are positioned on the loading surface 21.

The optical-electrical converter 30 is fixed on the PCB 20 to be received in the receiving groove 11. The optical-electrical converter 30 includes a cuboid substrate 31, a light-emitting module 32, a light-receiving module 33, a cuboid connecting block 34, a first converging lens 35, a second converging lens 36, a first fiber group 41, and a second fiber group 42.

The substrate 31 includes a first surface 311 and a second surface 312 perpendicular to the first surface 311. The first surface 311 has a number of second pads 313 aligning with the first pads 22.

The light emitting module 32 and the light receiving module 33 are positioned on the second surface 312, and are electrically connected to the PCB 20 through the first pads 22 and the second pads 313. The light emitting module 32 is used for converting a first electrical signal into a first optical signal, and emitting the first optical signal to another fiber connector (not shown). The light receiving module 33 is used for receiving a second optical signal from another fiber connector (not shown), and converting the second optical signal into a second electrical signal. In this embodiment, the light emitting module 32 is a laser diode, the light receiving module 33 is a photo diode. In this embodiment, both of the first electrical signal and the second electrical signal are current signals.

The first chip 23 is electrically connected to the light emitting module 32, and is used for providing the first electrical signal to the light emitting module 32. The second chip 24 is electrically connected to the light receiving module 33, and is used for converting the second electrical signal into a third electrical signal. In this embodiment, the third electrical signal is voltage signal.

The connecting block 34 is fixed on the second surface 312 of the substrate 31, and extends outwards from the opening 12. The connecting block 34 defines a first channel 341 and a second channel 342 parallel to the first channel 341. The first channel 341 and the second channel 342 pass through the connecting block 34, and are aligned with the light emitting module 32 and the light receiving module 33 respectively. The extending directions of the first channel 341 and the second channel 342 are parallel to the loading surface 21. The light emitting module 32 and the light receiving module 33 communicate with the first channel 341 and with the second channel 342 respectively.

The first converging lens 35 is received in the first channel 341, and is adjacent to the light emitting module 32. The second converging lens 36 is received in the second channel 342, and is adjacent to the light receiving module 33. The first converging lens 35 is used for converging the first optical signal from the light emitting module 32, and includes a number of first micro lenses 350 arranged in an array. The second converging lens 36 is used for converging the second optical signal into the light receiving module 33, and includes a number of second micro lenses 360 arranged in an array.

A third converging lens 37 is positioned on an end of the first channel 341 away from the substrate 31. The configuration of the third lens 37 is the same as the configuration of the first lens 35, and includes a number of third micro lenses 370 corresponding to the first micro lenses 350. A fourth converging lens 38 is positioned on an end of the second channel 342 away from the substrate 31. The configuration of the fourth converging lens 38 is the same as the configuration of the second converging lens 36, and includes a number of fourth micro lenses 380 corresponding to the second micro lenses 360.

The first fiber group 41 is used for transmitting the first optical signal, the second fiber group 42 is used for transmitting the second optical signal. The first fiber group 41 is received in the first channel 341, the second fiber group 42 is received in the second channel 342, and thus the extending directions of the first fiber group 41 and the second fiber group 42 are parallel to the loading surface 21. The first fiber group 41 includes a number of first fibers 410. An end of each first fiber 410 is aligned with and connected to a first micro lens 350 and another end of each of each first fiber 410 is aligned with a third micro lens 370. The second fiber group 42 includes a number of second fibers 420. An end of each second fiber 420 is aligned with and connected to a second micro lens 360 and another end of each second fiber 420 is aligned with a fourth micro lens 380.

In use, when the optical fiber connector 100 is used as an optical emitting terminal, the light emitting module 32 converts the first electrical signal from the first chip 23 to the first optical signal, the first converging lens 35 converges the first optical signal, the first optical signal is transmitted by the first fiber group 410 to the third converging lens 37, then enter another optical fiber connector (not shown).

When the optical fiber connector 100 is used as an optical receiving terminal, the second optical signal from the another optical fiber connector (not shown) is converged by the fourth converging lens 38, then the second fiber group 42 receives the second optical signal, the second optical signal is converged by the second converging lens 36, and is then received by the light receiving module 33. The light receiving module 33 converts the second optical signal into the second electrical signal, and the second electrical signal is transmitted to the second chip 24, the second chip 24 converts the second electrical signal into the third electrical signal.

The optical fiber connector 100 altogether avoids the need for reflectors, the optical signal is not reflected at any stage, and thus the signal loss is reduced, and the transmission efficiency of the light signal is improved.

The first converging lens 35, the second converging lens 36, the third converging lens 37 and the fourth converging lens 38 can be omitted when needed.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical fiber connector, comprising:
a shell defining a receiving groove which has an opening;
a printed circuit board (PCB) received in the receiving groove and comprising a loading surface;
an optical-electrical converter comprising:
a substrate electrically connected to the printed circuit board, the substrate comprising a first surface and a second surface connected to the first surface, the first surface positioned on the loading surface; and
a connecting block positioned on the second surface of the substrate and extending out of the receiving groove through the opening, the connecting block defining a first channel and a second channel parallel to the first channel, the extending directions of the first channel and the second channel parallel to the loading surface;
a light emitting module positioned on the second surface of the substrate and electrically connected to the PCB;
a light receiving module positioned on the second surface of the substrate and electrically connected to the PCB;
a first fiber group received in the first channel and optically aligned with the light emitting module; and
a second fiber group received in the second channel and optically aligned with the light receiving module.

2. The optical fiber connector of claim 1, wherein the PCB further comprises a first chip and a second chip, the first chip is electrically connected to the light emitting module, and is configured for providing a first electrical signal to the light emitting module, the light emitting module is configured for converting the first electrical into a first optical signal, the second chip is electrically connected to the light receiving module, the light receiving module is configured for receiving a second optical signal, and converting the second optical signal into a second electrical signal, the second chip is configured for converting the second electrical signal into a third electrical signal.

3. The optical fiber connector of claim 1, wherein the optical fiber connector further comprises a first converging lens and a second converging lens, the first converging lens is received in one end of the first channel adjacent to the light emitting module, the second converging lens is received in one end of the second channel adjacent to the light receiving module.

4. The optical fiber connector of claim 3, wherein the first converging lens comprises a plurality of first micro lenses, the second converging lens comprises a plurality of second micro lenses, the first fiber group comprises a plurality of first fibers optically aligned with the corresponding first micro lenses respectively, the second fiber group comprises a plurality of second fibers optically aligned with the corresponding second micro lenses respectively.

5. The optical fiber connector of claim 4, wherein the optical fiber connector further comprises a third converging lens and a fourth converging lens, the third converging lens is positioned on one end of the first channel away from the substrate, the configuration of the third converging lens is the same as the configuration of the first converging lens, the third converging lens comprises a plurality of third micro lenses corresponding to the first micro lenses, the fourth converging lens is positioned on one end of the second channel away form the substrate, the configuration of the fourth converging lens is the same as the configuration of the second converging lens, and the fourth converging lens comprises a plurality of fourth micro lenses corresponding to the second micro lenses.

6. The optical fiber connector of claim 5, wherein two ends of each fiber of the first fiber group contact with a corresponding first micro lens and a corresponding third micro lens respectively, two ends of each fiber of the second fiber group contact with a corresponding first micro lens and a corresponding third micro lens respectively.

7. The optical fiber connector of claim 1, wherein the loading surface positions a plurality of first pads, and the first surface positions a plurality of second pads corresponding to the first pads respectively.

8. The optical fiber connector of claim 1, wherein the second surface is perpendicular to the first surface.

9. The optical fiber connector of claim 1, wherein the light emitting module is a laser diode, and the light receiving module is a photo diode.
